(19) United States
(12) Patent Application Publication
(10) Pub. No.: US 2020/0109727 A1
(43) Pub. Date: Apr. 9, 2020

(54) SYSTEMS, METHODS, AND APPARATUS FOR IMPROVED CONVEYOR SYSTEM SLIP-JOINT TRACK

(71) Applicant: RSI, Inc., Louisville, KY (US)

(72) Inventors: Arthur Bernard Rhodes, II, Prospect, KY (US); Dustin Allen Rhodes, Louisville, KY (US)

(73) Assignee: RSI, Inc., Louisville, KY (US)

(21) Appl. No.: 16/546,255

(22) Filed: Aug. 20, 2019

Related U.S. Application Data
(60) Provisional application No. 62/720,099, filed on Aug. 20, 2018.

(51) Int. Cl. F16B 7/04; B65G 17/30

(52) U.S. Cl. CPC F16B 7/0426; B65G 17/30

(57) ABSTRACT

The invention relates generally to conveying systems, for moving work pieces from work station to work station including conveyors which generally move at a constant speed and include load carrying units which can be coupled for movement therewith between work stations and uncoupled from the conveyor so that they will be stationary at the work stations while work is done on a work piece carried by the load carrying units. More particularly, the present invention pertains to improved systems, methods, and apparatuses for joining, repairing, replacing, or altering conveyor system track and track configurations.

### FIELD OF THE INVENTION

The invention relates generally to conveying systems, and various related components, for moving work pieces from work station to work station including conveyors which generally move at a constant speed and include load carrying units which can be coupled for movement therewith between work stations and uncoupled from the conveyor so that they will be stationary at the work stations while work is done on a work piece carried by the load carrying units. More particularly, the present invention pertains to improved systems, methods, and apparatuses for joining, repairing, replacing, or altering conveyor system track and track configurations.

### BACKGROUND OF THE INVENTION

In the manufacturing industry today, many manufacturers utilize conveyor systems for easily and quickly moving products through various stages of the manufacturing process. For example, in the furniture industry, a piece of furniture may be placed on a conveyor cart connected to a conveyor system which passes through sanding stations, paint booths, finishing stations, hardware stations, etc. Existing conveyor systems typically consist of a series of conveyor carts upon which various items may be placed, a drive chain housing secured to the floor of the manufacturing facility through which a drive chain passes which pulls the conveyor carts, and a drive mechanism for providing locomotion to the chain and thereby moving the conveyor carts.

Examples of known conveying systems are set forth in a number of U.S. patents including U.S. Pat. Nos. 4,438,702; 4,638,740; 4,644,869; 4,770,285; 4,944,228; 4,947,978; 5,065,678; 5,299,680; 5,368,152; 5,538,126; 5,549,050, which are hereby incorporated by reference in their entirety. In these conveyor systems, the load carrying units are provided with vertically movable pins for engaging and disengaging with movable endless chains which move at a constant and continuous speed. Many different means have been used for moving these vertical pins from an engaging to a disengaging position and problems have been encountered in maintaining these pins in a disengaged position as the endless chain continues to move beneath the pins. U.S. Pat. Nos. 4,944,228; 5,368,152; 5,538,126; and 5,549,050, which are hereby incorporated by reference in their entirety, teach various means for stabilizing the engaging pins in a disengaged position.

Other embodiments of these conveying systems include overhead conveyers for propelling a carrier moveably along a track by an endless conveyor chain disposed within the track. The carrier is detachably connected to the chain and includes an uncoupling assembly for detaching the carrier from the chain. U.S. Pat. Nos. 6,378,440; 6,827,200; and 6,843,358, which are hereby incorporated by reference in their entirety, relate to various overhead conveyers.

Other known conveyor systems include U.S. Provisional Patent Application 61/793,030, with a filing date of Mar. 15, 2013, and entitled “SYSTEMS, METHODS, AND APPARATUS FOR IMPROVED CONVEYOR SYSTEM DRIVE” (Rhodes et al.); U.S. patent application Ser. No. 14/216,272, with a filing date of Mar. 17, 2014, and entitled “SYSTEMS, METHODS, AND APPARATUS FOR IMPROVED CONVEYOR SYSTEM DRIVE” (Rhodes et al.), issued as U.S. Pat. No. 9,969,561 on May 15, 2018; U.S. Provisional Patent Application 62/076,968, with a filing date of Nov. 7, 2014, and entitled “SYSTEMS, METHODS, AND APPARATUS FOR SYNCHRONOUS SET CENTER ENDLESS CHAIN DRIVE SYSTEM” (Rhodes et al.); U.S. patent application Ser. No. 13/223,234, with a filing date of Aug. 31, 2011, and entitled “SYSTEMS, METHODS, AND APPARATUS FOR IMPROVED CONVEYOR SYSTEM DRIVE” (Rhodes), issued as U.S. Pat. No. 9,096,383 on Aug. 4, 2015; and U.S. patent application Ser. No. 14/818,185, with a filing date of Aug. 4, 2015, and entitled “SYSTEMS, METHODS, AND APPARATUS FOR IMPROVED CONVEYOR SYSTEM” (Rhodes et al.), issued as U.S. Pat. No. 9,944,469 on Apr. 17, 2018 each of which is incorporated herein in the entirety.

With existing conveyor and track systems, whenever a new track section is to be added, a new conveyor system is installed, or whenever existing track sections are repaired or reconfigured, field welding is needed to join the track sections together. In field welding, two square-tube shaped track sections are precisely lined up and welded together in field conditions, such as on a factory floor. This process is difficult, time consuming, and error-prone. It can be difficult to precisely line up, cut, and measure existing or new track sections to be welded together to form a complete conveyor track. This problem is amplified when replacing or re-configuring track sections in existing conveyor systems.

What is needed is a system and method for reconfiguring, installing, and repairing conveyor track systems that does not require field welding.

### SUMMARY OF THE INVENTION

The present invention provides systems, methods, and apparatuses relating to improved conveying systems, and in particular to installing, reconfiguring, replacing, and repairing conveyor system tracks. Generally, the conveying system of the present invention is designed to adapt to most manufacturing needs, for example, from furniture manufacturing and finishing to marine and automotive engines. The versatility of the conveying system of the present invention is achieved by the use of a special slip-joint that can be easily placed over an existing track section and secured in place by bolts or set-screws and then joined to a new track section by nuts and bolts or screws to provide for the installing, reconfiguring, replacing, and repairing conveyor system tracks without welding. The conveyor track may be installed in a factory or other application without requiring track sections to be accurately welded together by a skilled expert. Instead, track sections may be joined together using the slip-joint placed over an existing track section and joined to a new or other track section by flanges and bolts or screws.

Although the invention is disclosed for joining straight track sections together, additional embodiments of the present invention may include a pusher station, an anti-backup component that provides a means to prevent roll-back of a cart during conveyor operation, an accumulator or close-pack configuration, a pin turner station to more effectively make the cart platform swivel or rotate about an axis (e.g., 90 degrees) to achieve a desired placement or positioning of the product begin carried on the cart for finishing, and an above-ground drive assembly for providing locomotion to the conveying system, among other components as described herein that may be joined together or to other track sections using the slip-joint system of the present invention.

In one embodiment, the present invention provides a weld-less track joining system comprising a slip-joint having a body and a face flange, the body adapted to fit over an existing track section, and a new track section having a body and a face flange, the body of the new track section smaller than and corresponding to the interior of the body of the slip-joint and similar in dimension to the existing track section, wherein the slip-joint may be fastened to the existing track section and the face of the slip-joint and the face of the new track section may be fastened together to create a continuous track section without welding.

In another embodiment the present invention provides a track joining system comprising: a slip-joint having a body and a face flange, the body adapted to fit over an existing track section; a new track section having a body and a face flange, the body of the new track section being smaller than and corresponding to an interior of the body of the slip-joint and similar in dimension to the existing track section; wherein the slip-joint may be fastened to the existing track section; and wherein the face flange of the slip-joint and the face flange of the new track section may be fastened together to create a continuous track section.

The track joining system of the above embodiment may further comprise wherein the existing track section and the new track section are elevated track sections. The slip-joint may be fastened to the existing track section by a set of set screws. The face flange of the slip-joint and the face flange of the new track section may be fastened together by a set of nuts and bolts. The track joining system may further comprise wherein a portion of the body of new track section corresponds to and is adapted mate with the interior of the body of the slip-joint. The slip-joint, the new track section, and the existing track section may each comprise a track channel. The track channel of each of the slip-joint, the new track section, and the existing track section may be adapted to permit a tow pin to engage with a tow chain disposed within each of the of the slip-joint, the new track section, and the existing track section.

In another embodiment, the present invention provides a weld-less track joining system comprising: a slip-joint having a body and a face flange, the body adapted to fit over an existing track section; a new track section having a body and a face flange, the body of the new track section being smaller than and corresponding to an interior of the body of the slip-joint and similar in dimension to the existing track section; a first set of fastening means adapted to fasten the slip-joint to the existing track section; and a second set of fastening means adapted to fasten the face flange of the slip-joint and the face flange of the new track section together to create a continuous track section without welding.

The weld-less track joining system of the above embodiment may further comprise wherein the existing track section and the new track section are elevated track sections. The first set of fastening means may comprise a set of set screws. The second set of fastening means may comprise a set of nuts and bolts. The weld-less track joining system may further comprise wherein a portion of the body of new track section corresponds to and is adapted mate with the interior of the body of the slip-joint. The slip-joint, the new track section, and the existing track section may each comprise a track channel. The track channel of each of the slip-joint, the new track section, and the existing track section may be adapted to permit a tow pin to engage with a tow chain disposed within each of the of the slip-joint, the new track section, and the existing track section.

In another embodiment, the present invention provides a weld-less track joining system for elevated conveyor tracks for use with hanging load carrying units, the weld-less track joining system comprising: a slip-joint having a body comprising a top, a bottom, an interior, an exterior, and a face flange, the interior of the body adapted to fit over an existing elevated track section, the body of the slip-joint having an opening disposed at the bottom, the opening corresponding to an opening in the existing elevated track section, the slip-joint comprising a set of openings adapted to permit a set of securing means to secure the slip-joint to the existing elevated track section; a new elevated track section having a body comprising a top and a bottom, and a face flange, the body of the new elevated track section being smaller than and corresponding to the interior of the body of the slip-joint and similar in dimension to the existing elevated track section, the new elevated track section comprising an opening disposed at the bottom; and wherein the face flange of the slip-joint and the face flange of the new track section may be fastened together to create a continuous track section without welding.

The weld-less track joining system for elevated conveyor tracks for use with hanging load carrying units of the above embodiment may further comprise wherein the set of securing means comprises a set of set screws. The face flange of the slip-joint and the face flange of the new elevated track section may be fastened together by a set of nuts and bolts. The weld-less track joining system for elevated conveyor tracks for use with hanging load carrying units may further comprise wherein a portion of the body of new elevated track section corresponds to and is adapted mate with the interior of the body of the slip-joint. The opening at the bottom of each of the slip-joint, the new elevated track section, and the existing track section may be a track channel. The track channel of each of the slip-joint, the new track section, and the existing track section may be adapted to permit a tow pin to engage with a tow chain disposed within each of the of the slip-joint, the new track section, and the existing track section.

In another embodiment, the present invention provides a track joining system for retrofitting or completing at least a portion of track including an existing or in-place track section, the track joining system comprising: a slip-joint having an elongated body and a face flange, the slip-joint elongated body adapted to fit over a portion of an existing track section; a new track section having an elongated body and a face flange, the new track elongated body being smaller than and adapted to slidingly fit into an interior of the slip-joint elongated body and being similar in dimension to an elongated body portion of an in-place track section; wherein the slip-joint may be fastened to the in-place track section; and wherein the face flange of the slip-joint and the face flange of the new track section may be fastened together such that the new track elongated body essentially mates to the in-place track section to create a continuous track for allowing passing of load-carrying units passing through the conjoined in-place track section and new track section.

The track joining system of the above embodiment may further comprise wherein the existing or in-place track section and the new track section are elevated track sections. The slip-joint may be fastened to the existing or in-place track section by a set of set screws. The face flange of the slip-joint and the face flange of the new track section may be fastened together by a set of nuts and bolts. The track joining system may further comprise wherein a portion of the body of new track section corresponds to and is adapted mate with the interior of the body of the slip-joint. The slip-joint, the new track section, and the existing or in-place track section may each comprise a track channel. The track channel of each of the slip-joint, the new track section, and the existing or in-place track section may be adapted to permit a tow pin to engage with a tow chain disposed within each of the of the slip-joint, the new track section, and the existing or in-place track section.

In another embodiment, the present invention provides a weld-less track joining system for retrofitting or completing at least a portion of track including an existing or in-place track section, the weld-less track joining system comprising: a slip-joint having a body and a face flange, the body adapted to fit over an existing track section; a new track section having a body and a face flange, the body of the new track section being smaller than and corresponding to an interior of the body of the slip-joint and similar in dimension to the existing track section; a first set of fastening means adapted to fasten the slip-joint to the existing track section; and a second set of fastening means adapted to fasten the face flange of the slip-joint and the face flange of the new track section together to create a continuous track section without welding.

The weld-less track joining system of the above embodiment may further comprise wherein the existing track section and the new track section are elevated track sections. The first set of fastening means may comprise a set of set screws. The second set of fastening means may comprise a set of nuts and bolts. The weld-less track joining system of the above embodiment may further comprise wherein a portion of the body of new track section corresponds to and is adapted mate with the interior of the body of the slip-joint. The slip-joint, the new track section, and the existing track section may each comprise a track channel. The track channel of each of the slip-joint, the new track section, and the existing track section may be adapted to permit a tow pin to engage with a tow chain disposed within each of the of the slip-joint, the new track section, and the existing track section.

In another embodiment, the present invention provides a weld-less track joining system for retrofitting or completing at least a portion of track including an existing or in-place track section for use with elevated conveyor tracks adapted to support and convey hanging load carrying units, the weld-less track joining system comprising: a slip-joint having a body comprising a top, a bottom, an interior, an exterior, and a face flange, the interior of the body adapted to fit over an existing or in-place elevated track section, the body of the slip-joint having an opening disposed at the bottom, the opening corresponding to an opening in the existing or in-place elevated track section, the slip-joint comprising a set of openings adapted to permit a set of securing means to secure the slip-joint to the existing or in-place elevated track section; a new elevated track section having a body comprising a top and a bottom, and a face flange, the body of the new elevated track section being smaller than and corresponding to the interior of the body of the slip-joint and similar in dimension to the existing or in-place elevated track section, the new elevated track section comprising an opening disposed at the bottom; and wherein the face flange of the slip-joint and the face flange of the new track section may be fastened together without welding such that the new elevated track section essentially mates to the existing or in-place track section to create a continuous track for allowing passing of load-carrying units passing through the conjoined existing or in-place track section and new track section.

The weld-less track joining system for elevated conveyor tracks for use with hanging load carrying units of the above embodiment may further comprise wherein the set of securing means comprises a set of set screws. The face flange of the slip-joint and the face flange of the new elevated track section may be fastened together by a set of nuts and bolts. The weld-less track joining system for elevated conveyor tracks for use with hanging load carrying units of the above embodiment may further comprise wherein a portion of the body of new elevated track section corresponds to and is adapted mate with the interior of the body of the slip-joint. The opening at the bottom of each of the slip-joint, the new elevated track section, and the existing or in-place track section may be a track channel. The track channel of each of the slip-joint, the new track section, and the existing or in-place track section may be adapted to permit a tow pin to engage with a tow chain disposed within each of the of the slip-joint, the new track section, and the existing or in-place track section.

### BRIEF DESCRIPTION OF DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 provides a perspective view of an embodiment of a slip-joint track system according to the present invention.

FIG. 2 provides a perspective view of an embodiment of a slip-joint track system according to the present invention.

FIG. 3 provides a side view of an embodiment of a slip-joint track system according to the present invention.

FIGS. 4-7 provide top, front and side views of an embodiment of a slip-joint track system according to the present invention.

FIGS. 8-11 provide top, front and side views of an embodiment of a track section for a slip-joint track system according to the present invention.

FIGS. 12-16 provide top, front and side views of an embodiment of a slip-joint track system according to the present invention.

FIGS. 17-20 provide perspective, top, front and side views of an embodiment of a slip-joint track system according to the present invention.

### DETAILED DESCRIPTION OF PREFERRED EMBODIMENT

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

The conveyor system as described herein may be implemented as an elevated (or high line or “hi-line”) conveyor system may comprise many of the elements of on surface conveyor systems including accumulators, turning devices, load carrying units, pushers, and one or more drive assemblies. The drive assemblies used in the elevated conveyor system may be either an elevated in-ground drive assembly such as those shown in U.S. Pat. Pub. 2013/0048472, or an elevated surface-mounted drive system. The elevated conveyor system uses components common with the surface-mounted counterpart but may also include a partial enclosure for any conveyor track to prevent dripping of lubricants or oils from the conveyor track or tow chain. In one embodiment, the elevated conveyor system comprises a set of conveyor track suspended or elevated by pylons, pillars, or other structures, a drive assembly, an accumulator, a load carrier turning mechanism, and a set of hanging load carriers.

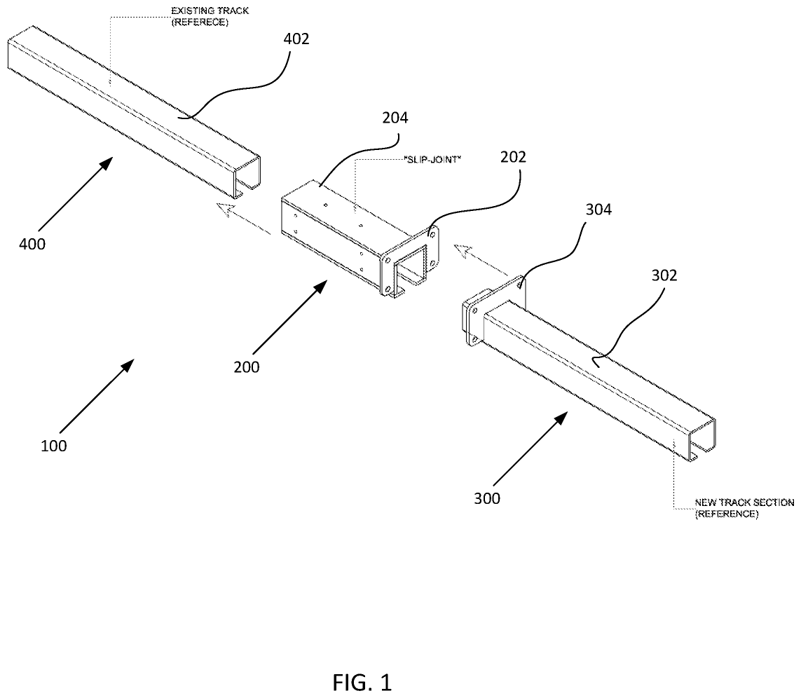

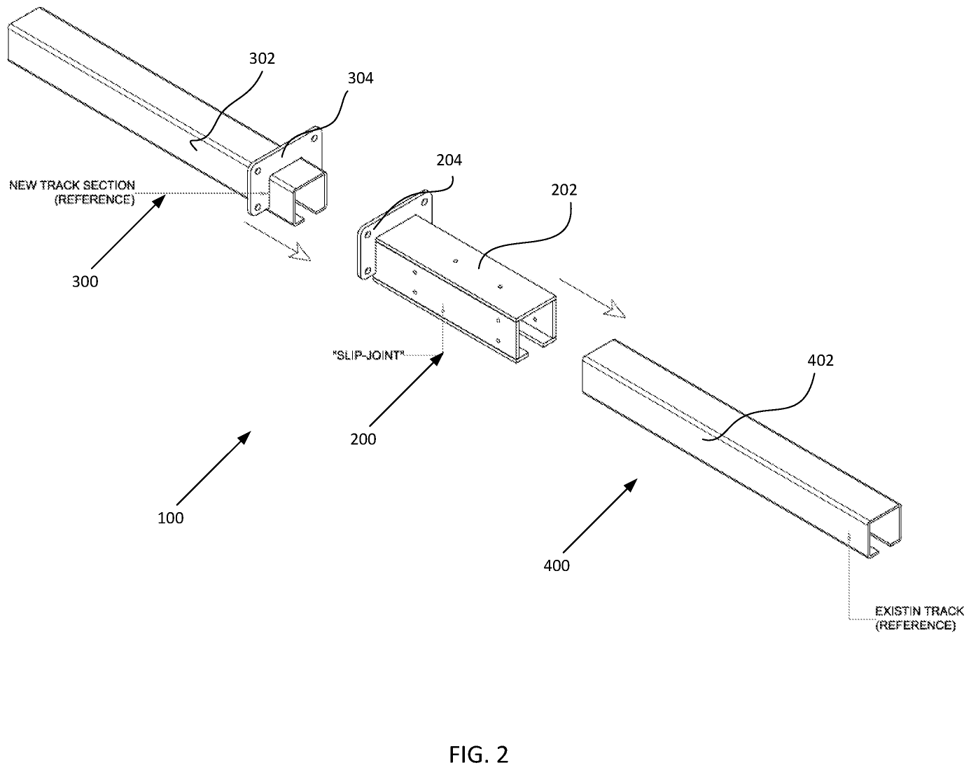

With reference now to FIGS. 1 and 2, a perspective view and a reverse perspective view of an embodiment of a slip-joint track system 100 according to the present invention is provided. The slip-joint track system 100 comprises a slip-joint 200, new track section 300, and existing track section 400. The slip-joint 200 comprises a slip joint body 204 and slip-joint face flange 202. The new track section 300 comprises a new track body 302 and new track face flange 304. The existing track section 400 comprises a track body 402. Each of the comprises a slip-joint 200, new track section 300, and existing track section 400 have a track channel in which a tow pin or hanging conveyor pin may fit to engage with a conveyor tow chain disposed within the track sections.

Typically, track sections are joined together for conveyor systems by welding pieces of track together directly. This process is difficult, labor intensive, and requires precise measurement and skill for an accurate joining of track sections. Field-welding, as this process is sometimes known, is not an ideal way to join, alter, or reconfigure track sections in new or existing conveyor systems. The slip-joint track system 100 of the present invention enables new sections of track to be added or sections of track to be re-configured using the slip-joint 200. An existing section of track 400 is cut, and the slip-joint 200 is placed over the track body 402 of the existing track section. The slip-joint body 202 fits over the track body 402 and is secured in place with fasteners, such as bolts or screws, or by welding the slip-joint 200 in place. Fasteners would provide for faster and easier installation and provide additional benefits over welding including easier adjustment and removal. Set-screws may also be used to secure the slip-joint 200 in place on the body 402 of the existing track section 400. After the slip-joint 200 has been installed over the existing track section, it can be mated with the new track section 300. The face 304 of the new track section 300 corresponds to and will abut the face 204 of the slip-joint 200. The two faces 304 and 204 are joined together by a set of fasteners which may be bolts and nuts or screws or rivets or other suitable securing means. A portion of the body 302 of the new track section 300 may be configured to engage and mate with the body 202 of the slip-joint 200 to provide additional strength and cohesiveness to the track join made by the slip-joint 200.

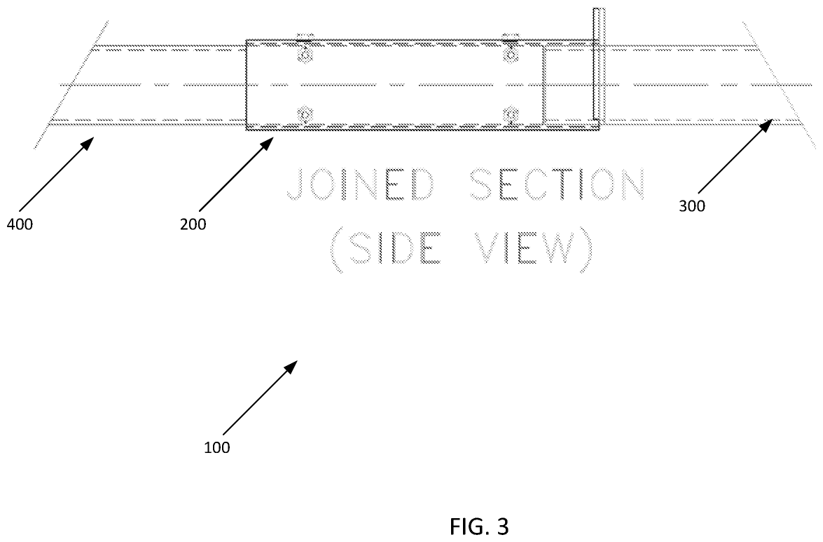

With reference now to FIG. 3, a side view of the slip-joint track system 100 with the slip-joint 200 joining a new track section 300 with an existing track section 400 is provided. The slip-joint 200 fits over the existing track section 400 and is secured in place with a set of fasteners. The new track section 300 engages and mates with the slip-joint 200 and the faces 304 and 204 abut one another and are joined by a set of fasteners. The joining of track sections using the slip-joint track system 100 is substantially quicker and easier than field welding track sections together and also permits for the slight misalignment of track sections to be joined as the slip-joint 200 can somewhat compensate for a misalignment or mis-measurement causing a track section to be too short.

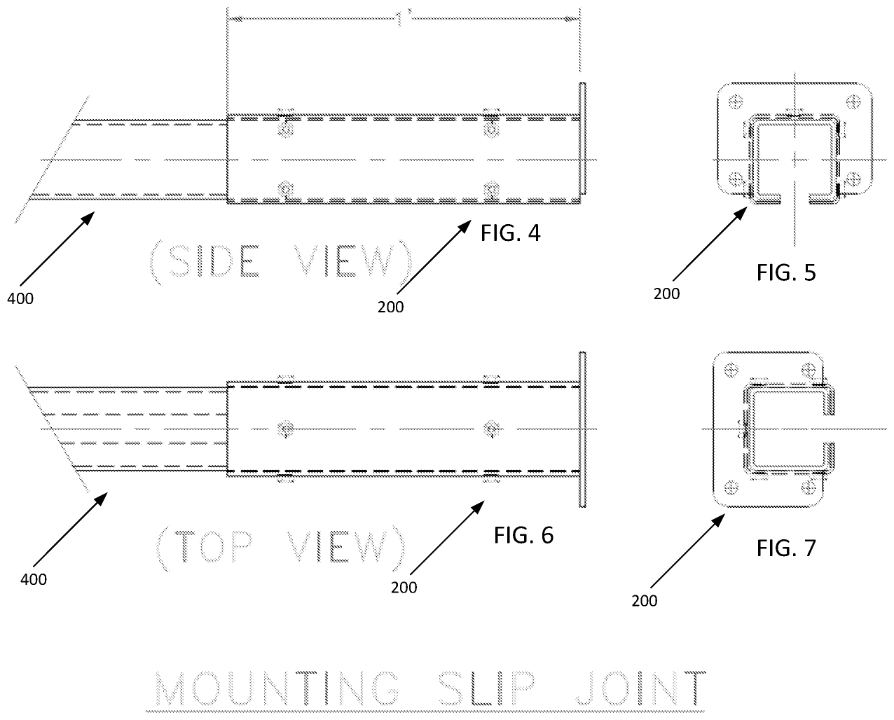

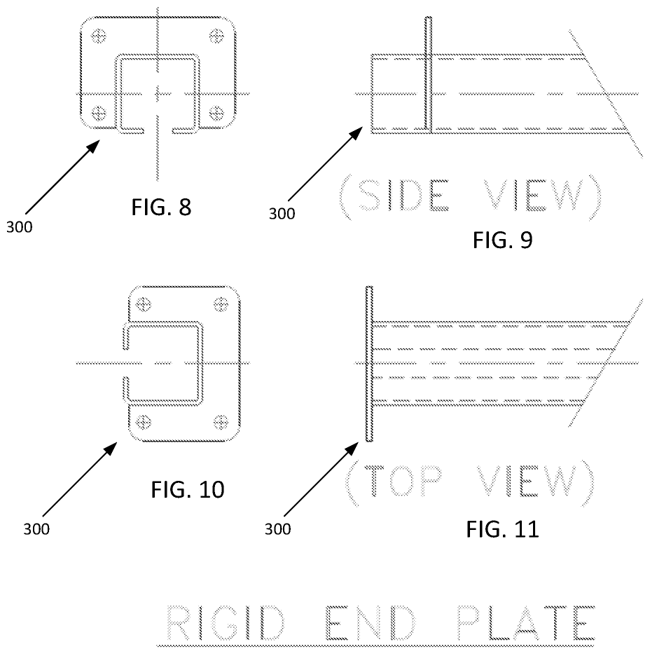

FIGS. 4-7 provide top, front and side views of an embodiment of a slip-joint track system 100 according to the present invention. FIGS. 4-7 show the slip-joint 200 installed on an existing track section 400. The face 204 of the slip-joint 200 is aligned with the end of the body 402 of the track section 400. The body 202 of the slip-joint 200 is secured to the body 402 of the track section 400 by a set of fasteners. The size and shape or dimensions of the interior of the slip-joint 200 correspond to and are slightly larger than those of the existing track section 400 such that the existing track section 400 body 402 fits directly within the slip-joint 200 for a secure fit when fastened by a set of fasteners. The new track section 300 and face 304 are shown in greater detail in the front, top and side views provided in FIGS. 8-11. The end of the body 302 of the new track section 300 corresponds to and is slightly smaller than the body 202 of the slip-joint 200 such that it fits securely within the body 202 of the slip-joint 200 when the face 304 of the new track section 300 abuts the face 204 of the slip-joint 200. The body 304 of the new track section 300 is typically the same in dimension to that of the body 402 of the existing track section 400.

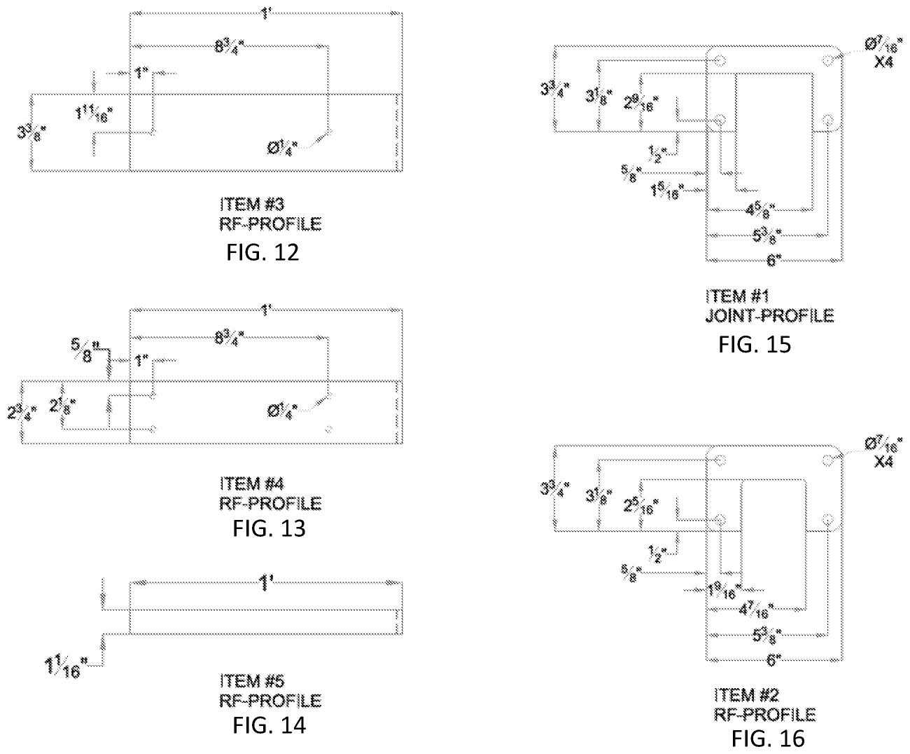

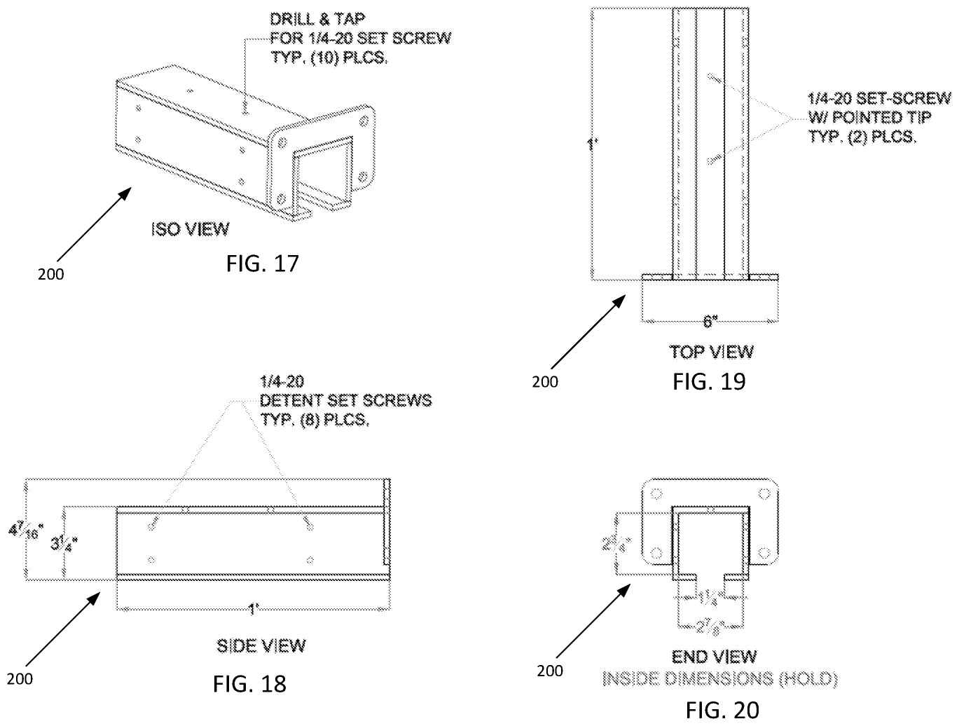

Dimensions for the slip-joint 200 are shown in FIGS. 12-15 and 17-20. The slip-joint 200 may comprise five separate plates welded together to form the body 202 of the slip-joint 200. The body 202 may comprise two side plates, shown in FIG. 13, a top plate, shown in FIG. 12, and two bottom plates, shown in FIG. 14, welded together with the face plate 204, shown in FIG. 15, to form the complete slip-joint 200 as shown in FIGS. 17-20. The face 304 of the new track section shown in FIG. 16 may be dimensionally similar on the exterior but may be smaller internally such that it corresponds to and fits over the body 302 of the new track section 300.

In another embodiment, the present invention provides a track joining system for retrofitting or completing at least a portion of track including an existing or in-place track section, the track joining system comprising: a slip-joint having an elongated body and a face flange, the slip-joint elongated body adapted to fit over a portion of an existing track section; a new track section having an elongated body and a face flange, the new track elongated body being smaller than and adapted to slidingly fit into an interior of the slip-joint elongated body and being similar in dimension to an elongated body portion of an in-place track section; wherein the slip-joint may be fastened to the in-place track section; and wherein the face flange of the slip-joint and the face flange of the new track section may be fastened together such that the new track elongated body essentially mates to the in-place track section to create a continuous track for allowing passing of load-carrying units passing through the conjoined in-place track section and new track section.

The track joining system of the above embodiment may further comprise wherein the existing or in-place track section and the new track section are elevated track sections. The slip-joint may be fastened to the existing or in-place track section by a set of set screws. The face flange of the slip-joint and the face flange of the new track section may be fastened together by a set of nuts and bolts. The track joining system may further comprise wherein a portion of the body of new track section corresponds to and is adapted mate with the interior of the body of the slip-joint. The slip-joint, the new track section, and the existing or in-place track section may each comprise a track channel. The track channel of each of the slip-joint, the new track section, and the existing or in-place track section may be adapted to permit a tow pin to engage with a tow chain disposed within each of the of the slip-joint, the new track section, and the existing or in-place track section.

In another embodiment, the present invention provides a weld-less track joining system for retrofitting or completing at least a portion of track including an existing or in-place track section, the weld-less track joining system comprising: a slip-joint having a body and a face flange, the body adapted to fit over an existing track section; a new track section having a body and a face flange, the body of the new track section being smaller than and corresponding to an interior of the body of the slip-joint and similar in dimension to the existing track section; a first set of fastening means adapted to fasten the slip-joint to the existing track section; and a second set of fastening means adapted to fasten the face flange of the slip-joint and the face flange of the new track section together to create a continuous track section without welding.

The weld-less track joining system of the above embodiment may further comprise wherein the existing track section and the new track section are elevated track sections. The first set of fastening means may comprise a set of set screws. The second set of fastening means may comprise a set of nuts and bolts. The weld-less track joining system of the above embodiment may further comprise wherein a portion of the body of new track section corresponds to and is adapted mate with the interior of the body of the slip-joint. The slip-joint, the new track section, and the existing track section may each comprise a track channel. The track channel of each of the slip-joint, the new track section, and the existing track section may be adapted to permit a tow pin to engage with a tow chain disposed within each of the of the slip-joint, the new track section, and the existing track section.

In another embodiment, the present invention provides a weld-less track joining system for retrofitting or completing at least a portion of track including an existing or in-place track section for use with elevated conveyor tracks adapted to support and convey hanging load carrying units, the weld-less track joining system comprising: a slip-joint having a body comprising a top, a bottom, an interior, an exterior, and a face flange, the interior of the body adapted to fit over an existing or in-place elevated track section, the body of the slip-joint having an opening disposed at the bottom, the opening corresponding to an opening in the existing or in-place elevated track section, the slip-joint comprising a set of openings adapted to permit a set of securing means to secure the slip-joint to the existing or in-place elevated track section; a new elevated track section having a body comprising a top and a bottom, and a face flange, the body of the new elevated track section being smaller than and corresponding to the interior of the body of the slip-joint and similar in dimension to the existing or in-place elevated track section, the new elevated track section comprising an opening disposed at the bottom; and wherein the face flange of the slip-joint and the face flange of the new track section may be fastened together without welding such that the new elevated track section essentially mates to the existing or in-place track section to create a continuous track for allowing passing of load-carrying units passing through the conjoined existing or in-place track section and new track section.

The weld-less track joining system for elevated conveyor tracks for use with hanging load carrying units of the above embodiment may further comprise wherein the set of securing means comprises a set of set screws. The face flange of the slip-joint and the face flange of the new elevated track section may be fastened together by a set of nuts and bolts. The weld-less track joining system for elevated conveyor tracks for use with hanging load carrying units of the above embodiment may further comprise wherein a portion of the body of new elevated track section corresponds to and is adapted mate with the interior of the body of the slip-joint. The opening at the bottom of each of the slip-joint, the new elevated track section, and the existing or in-place track section may be a track channel. The track channel of each of the slip-joint, the new track section, and the existing or in-place track section may be adapted to permit a tow pin to engage with a tow chain disposed within each of the of the slip-joint, the new track section, and the existing or in-place track section.

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1) A track joining system for retrofitting or completing at least a portion of track including an existing or in-place track section, the track joining system comprising:
a slip-joint having an elongated body and a face flange, the slip-joint elongated body adapted to fit over a portion of an existing track section;
a new track section having an elongated body and a face flange, the new track elongated body being smaller than and adapted to slidingly fit into an interior of the slip-joint elongated body and being similar in dimension to an elongated body portion of an in-place track section;
wherein the slip-joint may be fastened to the in-place track section; and
wherein the face flange of the slip-joint and the face flange of the new track section may be fastened together such that the new track elongated body essentially mates to the in-place track section to create a continuous track for allowing passing of load-carrying units passing through the conjoined in-place track section and new track section.

2) The track joining system of claim 1, wherein the existing or in-place track section and the new track section are elevated track sections.

3) The track joining system of claim 1, wherein the slip-joint is fastened to the existing or in-place track section by a set of set screws.

4) The track joining system of claim 1, wherein the face flange of the slip-joint and the face flange of the new track section are fastened together by a set of nuts and bolts.

5) The track joining system of claim 1, wherein a portion of the body of new track section corresponds to and is adapted mate with the interior of the body of the slip-joint.

6) The track joining system of claim 1, wherein the slip-joint, the new track section, and the existing or in-place track section each comprise a track channel.

7) The track joining system of claim 6, wherein the track channel of each of the slip-joint, the new track section, and the existing or in-place track section is adapted to permit a tow pin to engage with a tow chain disposed within each of the of the slip-joint, the new track section, and the existing or in-place track section.

8) A weld-less track joining system for retrofitting or completing at least a portion of track including an existing or in-place track section, the weld-less track joining system comprising:
a slip-joint having a body and a face flange, the body adapted to fit over an existing track section;
a new track section having a body and a face flange, the body of the new track section being smaller than and corresponding to an interior of the body of the slip-joint and similar in dimension to the existing track section;
a first set of fastening means adapted to fasten the slip-joint to the existing track section; and
a second set of fastening means adapted to fasten the face flange of the slip-joint and the face flange of the new track section together to create a continuous track section without welding.

9) The weld-less track joining system of claim 8, wherein the existing track section and the new track section are elevated track sections.

10) The weld-less track joining system of claim 8, wherein the first set of fastening means comprises a set of set screws.

11) The weld-less track joining system of claim 8, wherein the second set of fastening means comprises a set of nuts and bolts.

12) The weld-less track joining system of claim 8, wherein a portion of the body of new track section corresponds to and is adapted mate with the interior of the body of the slip-joint.

13) The weld-less track joining system of claim 8, wherein the slip-joint, the new track section, and the existing track section each comprise a track channel.

14) The weld-less track joining system of claim 13, wherein the track channel of each of the slip-joint, the new track section, and the existing track section is adapted to permit a tow pin to engage with a tow chain disposed within each of the of the slip-joint, the new track section, and the existing track section.

15) A weld-less track joining system for retrofitting or completing at least a portion of track including an existing or in-place track section for use with elevated conveyor tracks adapted to support and convey hanging load carrying units, the weld-less track joining system comprising:
a slip-joint having a body comprising a top, a bottom, an interior, an exterior, and a face flange, the interior of the body adapted to fit over an existing or in-place elevated track section, the body of the slip-joint having an opening disposed at the bottom, the opening corresponding to an opening in the existing or in-place elevated track section, the slip-joint comprising a set of openings adapted to permit a set of securing means to secure the slip-joint to the existing or in-place elevated track section;
a new elevated track section having a body comprising a top and a bottom, and a face flange, the body of the new elevated track section being smaller than and corresponding to the interior of the body of the slip-joint and similar in dimension to the existing or in-place elevated track section, the new elevated track section comprising an opening disposed at the bottom; and
wherein the face flange of the slip-joint and the face flange of the new track section may be fastened together without welding such that the new elevated track section essentially mates to the existing or in-place track section to create a continuous track for allowing passing of load-carrying units passing through the conjoined existing or in-place track section and new track section.

16) The weld-less track joining system for elevated conveyor tracks for use with hanging load carrying units of claim 15, wherein the set of securing means comprises a set of set screws.

17) The weld-less track joining system for elevated conveyor tracks for use with hanging load carrying units of claim 15, wherein the face flange of the slip-joint and the face flange of the new elevated track section are fastened together by a set of nuts and bolts.

18) The weld-less track joining system for elevated conveyor tracks for use with hanging load carrying units of claim 15, wherein a portion of the body of new elevated track section corresponds to and is adapted mate with the interior of the body of the slip-joint.

19) The weld-less track joining system for elevated conveyor tracks for use with hanging load carrying units of claim 15, wherein the opening at the bottom of each of the slip-joint, the new elevated track section, and the existing or in-place track section is a track channel.

20) The weld-less track joining system for elevated conveyor tracks for use with hanging load carrying units of claim 19, wherein the track channel of each of the slip-joint, the new track section, and the existing or in-place track section is adapted to permit a tow pin to engage with a tow chain disposed within each of the of the slip-joint, the new track section, and the existing or in-place track section.
